(19) United States
(12) Patent Application Publication
(10) Pub. No.: US 2013/0118437 A1
(43) Pub. Date: May 16, 2013

(54) MULTI ALLOY CYLINDER HEAD AND A METHOD OF MANUFACTURING THE SAME

(71) Applicant: Dong Ho Kwak, Yongin (KR)

(72) Inventor: Dong Ho Kwak, Yongin (KR)

(73) Assignee: HYUNDAI MOTOR COMPANY, Seoul (KR)

(21) Appl. No.: 13/524,153

(22) Filed: Jun. 15, 2012

(30) Foreign Application Priority Data
Nov. 16, 2011 (KR) 10-2011-0119735

(51) Int. Cl. F02F 1/40; B23P 17/00; F02F 1/24

(52) U.S. Cl. 123/193.5; 29/888.06

(57) ABSTRACT

The disclosure provides a multi alloy cylinder head that includes a lower part and an upper part connected to each other to form the cylinder head, and a method of manufacturing the same. The lower part includes a combustion chamber face and a water jacket face and may be prepared by, for example, casting or forging. The upper part includes a water jacket face and a cam installation face, and may be prepared by casting or forging. The water jacket face of the upper part and the lower part may be connected to form the cylinder head, with the water jacket situated between the upper and lower parts. The method of the disclosure allows fabrication of engine components from multiple sub-components made of different alloys.

### CROSS-REFERENCE TO RELATED APPLICATION

This application claims under 35 U.S.C. §119(a) the benefit of Korean Patent Application No. 10-2011-0119735 filed on Nov. 16, 2011, the entire contents of which are incorporated herein by reference.

### BACKGROUND

(a) Technical Field

The present disclosure relates to a multi alloy cylinder head, and a method of manufacturing the same. More particularly, the present disclosure relates to a multi alloy cylinder head including a lower portion and an upper portion made of different alloys, and a method of manufacturing the same.

(b) Background Art

The present invention relates to a technique for manufacturing a cylinder head, an essential component of an internal-combustion engine. In recent years, automobile manufacturers have focused on increasing engine output and fuel efficiency by seeking ways of developing lighter weight engines. However, as engine performance and output has increased, the operating environment of the engine has become harsher and the structure has become more intricate and complex, making it difficult to find suitable materials and manufacturing techniques with which to manufacture light weight engine components such as, for example, the cylinder head.

Consequently, there have been many efforts to develop an alloy that can be used to manufacture a light weight cylinder head capable of enhanced output and performance, while also increasing fuel efficiency. Generally, conventional art techniques have sought to do this by molding the complex shape of the cylinder head (e.g. the complex internal structure of the cylinder head water jacket) by using, for example, a sand core (e.g. green sand cores, dry-sand cores, and the like) in the interior of the cylinder head during casting to form the cylinder head and its intricate internal structures, and then pulverizing/vibrating the sand core in order to remove the core once the cylinder head has been cast. Unfortunately, the use of sand cores can create structural weaknesses at junctions within the mold because it is difficult to anticipate the cooling effect. This has proven to be a particular problem with respect to the development of high output engines such as gas direct injection (GDI), T-GDI, and the like.

Thus, there is a need in the art for the development alloys and methods for developing lighter weight and higher performing cylinder heads.

### SUMMARY OF THE DISCLOSURE

The present invention provides a multi alloy cylinder head, and a method of manufacturing the same. In particular, the method improves the material properties of the cylinder head by using a mold cooling method during casting, rather than sand cores.

The multi alloy cylinder head according to an exemplary embodiment of the present invention comprises: a lower part of the cylinder head, which is constructed so that a bottom face forms a combustion chamber face and a top face forms a water jacket face opposite the combustion chamber, and may be prepared by casting or forging; and an upper part of the cylinder head, which is constructed so that a bottom face forms a water jacket face and a top face forms a cam installation face, and may be prepared by casting or forging, wherein the bottom face of the upper part is connected to the top face of the lower part of the cylinder head, and the water jacket is formed therebetween. The upper and lower parts of the cylinder head can be prepared with an aluminum alloy.

The lower part of the cylinder head may be prepared by a gravity casting method. Both the top and bottom faces of the lower part of the cylinder head may be heated by subjecting them to a solution treatment of 500° C./3 hours and to an aging treatment of 250° C./2.5 hours after casting. The lower part of the cylinder head can be prepared as an aluminum alloy that comprises Al as a major component, Cu: 2.0-4.0 wt %, Si: 5.0-7.0 wt %, Mg: 0.1-0.4 wt %, Zn: 1.0 wt % or less (not including 0), Fe: 0.25 wt % or less (not including 0), Mn: 0.03 wt % or less (not including 0), Ni: 0.3 wt % or less (not including 0), Ti: 0.03 wt % or less (not including 0) and other indispensable impurities.

The upper part of the cylinder head can be prepared by die casting method. Both the top and bottom faces of the lower part of the cylinder head can be subjected to a heat treatment of 250° C./2.5 hours after casting. The upper part of the cylinder head can be prepared as an aluminum alloy that comprises Al as a major component, Cu: 1.5-3.5 wt %, Si: 9.6-12.0 wt %, Mg: 0.3 wt % or less (not including 0), Zn: 1.0 wt % or less (not including 0), Fe: 1.3 wt % or less (not including 0), Mn: 0.5 wt % or less (not including 0) and other indispensable impurities.

According to an exemplary embodiment of the invention, the upper and lower parts of the cylinder head may be connected to each other by an inorganic binder. According to another exemplary embodiment of the invention, the he upper and lower parts of the cylinder head may be connected to each other by an inorganic binder and a metal gasket between the bottom face of the upper part and top face of the lower part. The upper and lower parts of the cylinder head can be pre-assembled by a head bolt and then completely finished.

According to an aspect of the invention, a method for manufacturing the multi alloy cylinder head comprises: a lower part casting step of preparing the lower part of the cylinder head by a gravity casting method and heating both the top and bottom faces; an upper part casting step of preparing the upper part of the cylinder head by a die casting method and heating both of the top and bottom faces; and a connecting step of connecting the upper and lower parts of the cylinder head each other by coating an adhesive on the top face of the lower part and the bottom face of the upper part of the cylinder head and inserting a gasket therebetween. The connecting step may further comprise a finishing step of pre-assembling the head bolt penetrating the upper and lower parts of the cylinder head and completely finishing.

In the casting step for the lower part, both the top and bottom faces can be subjected to a solution treatment of 500° C./3 hours and an aging treatment of 250° C./2.5 hours after casting the lower part of the cylinder head.

In the upper part casting step, both of the top and bottom faces can be subjected to a heat treatment of 250° C./2.5 hours after casting the lower part of the cylinder head.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 is a drawing representing a lower part mold according to an exemplary embodiment of the present invention;

FIG. 2 is a drawing representing an upper part mold according to an exemplary embodiment of the present invention;

FIG. 3 is a drawing representing an exemplary process of connecting the lower and upper parts of the multi alloy cylinder head illustrated in FIGS. 1 and 2 to each other; and

FIG. 4 is a drawing of the lower part of the multi alloy cylinder head illustrated in FIG. 1 from the upper direction.

It should be understood that the appended drawings are not necessarily to scale, presenting a somewhat simplified representation of various preferred features illustrative of the basic principles of the invention. In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

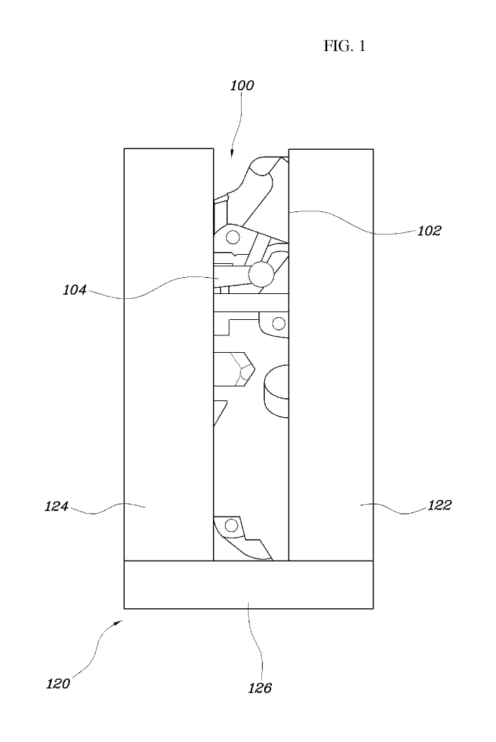

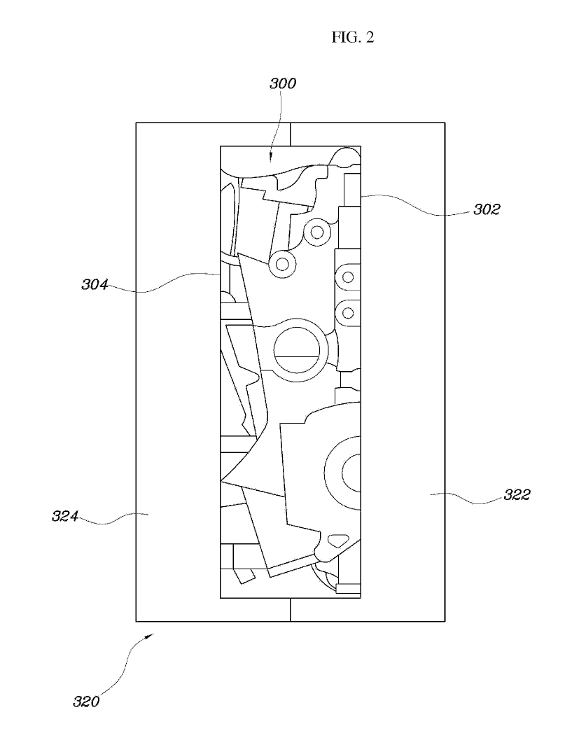

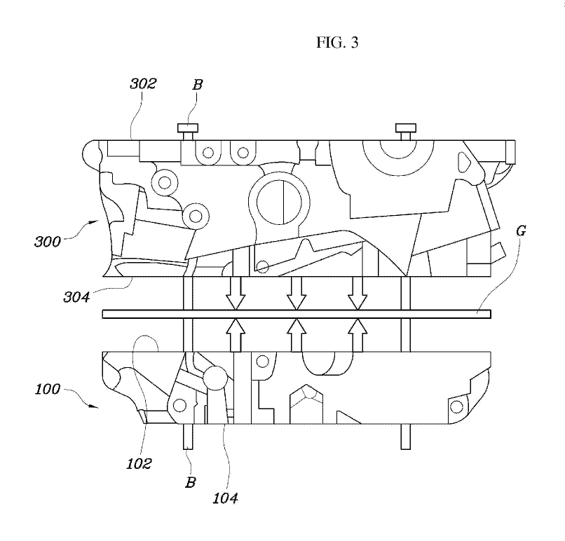

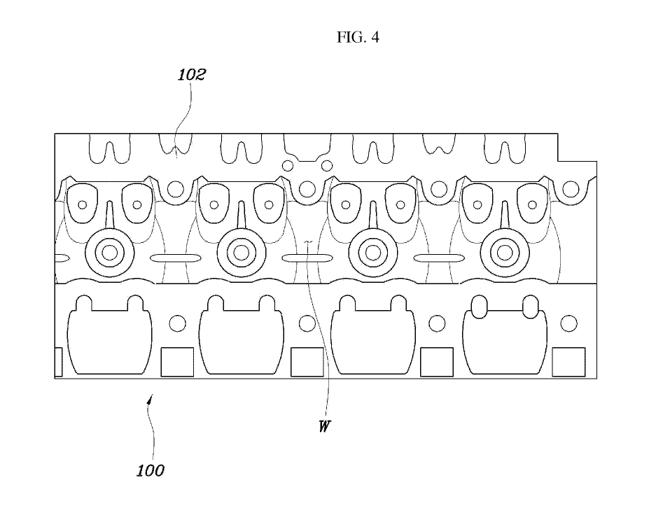

FIG. 1 is a drawing representing a lower part mold according to an exemplary embodiment of the present invention; FIG. 2 is a drawing representing an upper part mold according to an exemplary embodiment of the present invention; FIG. 3 is a drawing representing a process of connecting the lower and upper parts of the multi alloy type cylinder head illustrated in FIGS. 1 and 2 to each other; and FIG. 4 is a drawing viewing the lower part of the multi alloy type cylinder head illustrated in FIG. 1 from the upper direction.

The multi alloy cylinder head according to an exemplary embodiment of the present invention includes: a lower part 100 of the cylinder head, which is constructed so that a bottom face 104 forms a combustion chamber face and a top face 102 forms a water jacket W face opposite from the combustion chamber face, and prepared by casting or forging; and an upper part 300 of the cylinder head, which is constructed so that a bottom face 304 forms a water jacket W face and a top face 302 forms a cam installation face, and prepared by casting or forging, wherein the bottom face 304 is connected to the top face 102 of the lower part 100 of the cylinder head, and the water jacket W is formed therebetween.

According to an exemplary embodiment, it is possible to form a multi alloy structure having more than 2 layers (e.g., 3 layers, 4 layers, or more) by further comprising a core between the upper part 300 and lower part 100 of the cylinder head. If the cylinder head is prepared to have 3 layers, it is preferred to form the water jacket between the lower part, the core, and the upper part.

According to an exemplary embodiment of the present invention, the upper part 300 and the lower part 100 of the cylinder head can be prepared with an aluminum alloy. Moreover, the upper part 300 and the lower part 100 may be made of different alloys (e.g., different Al alloys), thereby allowing fabrication of a multi alloy component such as, for example, a cylinder head, that is fabricated in multiple pieces, where each piece is made of a different alloy. It is contemplated within the scope of the invention that the aforementioned fabrication technique may be used to assemble a component made from multiple pieces, where one or more of the different pieces is made of the same, or similar, alloy. The material will be described in detail as follows.

FIG. 1 is a drawing representing a lower part mold according to an exemplary embodiment of the present invention, and FIG. 4 is a drawing viewing the lower part of the multi alloy type cylinder head illustrated in FIG. 1 from the upper direction. The lower part 100 of the cylinder head can be prepared by gravity casting method. Herein, in the lower part 100 of the cylinder head, the top face 102 forms the water jacket W face, and the bottom face 104 forms the top face of the combustion chamber. After casting using molds 122, 124, and 126, both the top face 102 and the bottom face 104 are heated by subjecting them to a solution treatment of 500° C./3 hours and an aging treatment of 250° C./2.5 hours and also the conventional water jacket W part is heated, so as to obtain the desired material properties.

According to an exemplary embodiment of the present invention, the lower part 100 of the cylinder head can be prepared to comprise Al as a major component, Cu: 2.0-4.0 wt %, Si: 5.0-7.0 wt %, Mg: 0.1-0.4 wt %, Zn: 1.0 wt % or less (not including 0), Fe: 0.25 wt % or less (not including 0), Mn: 0.03 wt % or less (not including 0), Ni: 0.3 wt % or less (not including 0), Ti: 0.03 wt % or less (not including 0) and other indispensable impurities.

According to an exemplary embodiment of the present invention, the lower part 100 of the cylinder head can be prepared to comprise Al as a major component, Cu: 2.0-4.0 wt %, Si: 5.0-7.0 wt %, Mg: 0.1-0.4 wt %, Zn: 1.0 wt % or less (not including 0), Fe: 0.25 wt % or less (not including 0), Ni: 0.3 wt % or less (not including 0), Ti: 0.03 wt % or less (not including 0) and other indispensable impurities.

FIG. 2 is a drawing representing an exemplary embodiment of the present invention, and the upper part 300 of the cylinder head can be prepared by a die casting method. For example, the upper part 300 of the cylinder head may be casted using molds 322 and 324 followed by subjecting both the top and bottom faces to a heat treatment of 250° C./2.5 hours, and also the bottom face 304 of the upper part 300 constituting the water jacket W of the cylinder head is heated to obtain the desired material properties.

The upper part 300 of the cylinder head may be prepared to comprise Al as a major component, Cu: 1.5-3.5 wt %, Si: 9.6-12.0 wt %, Mg: 0.3 wt % or less (not including 0), Zn: 1.0 wt % or less (not including 0), Fe: 1.3 wt % or less (not including 0), Mn: 0.5 wt % or less (not including 0) and other indispensable impurities.

FIG. 3 is a drawing representing an exemplary process to connect the lower and upper parts of the multi alloy cylinder head illustrated in FIGS. 1 and 2 to each other, and the upper part 300 and the lower part 100 of the cylinder head manufactured by casting are connected to each other by an inorganic binder.

Further, in another exemplary embodiment, the upper part 300 and the lower part 100 of the cylinder head can be connected to each other between the bottom face 304 of the upper part 300 and the top face 102 of the lower part 100 with an inorganic binder and metal-based gasket G, and the upper part 300 and the lower part 100 of the cylinder head can be pre-assembled by the head bolt B and then completely finished.

This method for manufacturing a multi alloy cylinder head, comprises: a lower part casting step of preparing the lower part of the cylinder head by a gravity casting method and heating both of the top and bottom faces; an upper part casting step of preparing the upper part of the cylinder head by a die casting method and heating both of the top and bottom faces; and a connecting step of connecting the upper and lower parts of the cylinder head each other by coating an adhesive on the top face of the lower part and the bottom face of the upper part of the cylinder head and inserting the gasket therebetween.

Further, the connecting step may further comprise a finishing step of pre-assembling the head bolt penetrating the upper and lower parts of the cylinder head and completely finishing the assembly of the cylinder head.

Specifically, in the casting step for the lower part casting step, both of the top and bottom faces may be subjected to a solution treatment of 500° C./3 hours and an aging treatment of 250° C./2.5 hours after casting the lower part of the cylinder head, and in the upper part casting step, both the top and bottom faces can be subjected to a heat treatment of 250° C./2.5 hours after casting the upper part of the cylinder head. Through these steps, all of each top and bottom faces of the upper and the lower parts of the cylinder head are heated to more completely obtain the desired material properties and to draw out the optimum performance of the material when necessary and/or desired.

Specifically, the cylinder head was prepared according to the above described manufacturing method and tested, and the results are shown in Table 1. The following Table 1 represents a test composition of the lower part of the cylinder head, and the Table 2 represents a test composition of the upper part of the cylinder head.

TABLE 1

| Component | Cu | Si | Mg | Zn | Fe | Mn | Ni | Ti | Al |
|---|---|---|---|---|---|---|---|---|---|
| Composition | 2.0 | 5.0 | 0.1 | 1.0 | 0.25 | 0.03 | 0.3 | 0.03 | Rem. |
| | ~4.0 | ~7.0 | ~0.4 | Max. | Max. | Max. | Max. | Max. | |
| Test | 2.28 | 6.64 | 0.18 | 0.014 | 0.12 | — | 0.012 | 0.025 | Rem. |
| Example | | | | | | | | | |

TABLE 2

| Component | Cu | Si | Mg | Zn | Fe | Mn | Al |
|---|---|---|---|---|---|---|---|
| Composition | 1.5 | 9.6 | 0.3 | 1.0 | 1.3 | 0.53 | Rem. |
| | ~3.5 | ~12.0 | or less | or less | or less | or less | |
| Test Example | 2.06 | 11.19 | 0.23 | 0.94 | 0.83 | 0.24 | Rem. |

When preparing the cylinder head by connecting the upper part and the lower part of the cylinder head, which were casted with the above described Al alloys and heated according to the above described method, it was confirmed that the material properties of the resulting structure/component (e.g., the inner face of the water jacket) were improved to the tensile strength of 235-259 MPa and the elongation ratio of 0.9-1.7%, and the elongation ratio directly affecting to the fatigue strength was improved at least 26%, and the elongation ratio directly related to the high temperature fatigue property was improved about 60% or more. In comparison, a conventional art all-in-one cylinder head generally has test values in which the tensile strength is 156-186 MPa and the elongation ratio of 0.27-0.33%. Consequently, the present invention produces a multi alloy cylinder head with vastly superior material properties.

This improvement of the material properties is also advantageous because it can reduce the cost and time required to develop a new engine types because it can apply the rigidity and high temperature property required for a high output engine without any special material development to the proven material for mass production.

Further, in a production step, it is expected to obtain effects of enhancing yield, minimizing cycle time and reducing weight by improving the material rigidity by applying high pressure die casting having excellent productivity, and can reduce the generation amount of the core gas 100%.

According to the multi-layer type cylinder head consisting of the structure described above, and the manufacturing method thereof, the material properties can be improved by substituting the conventional art use of casting cores with a cooling method using a mold casting method, rather than a typically core, such as a green sand core.

Specifically, the material properties of the joining surface was improved to the tensile strength of 235-259 MPa and the elongation ratio of 0.9-1.7%, and the elongation ratio directly affecting to the fatigue strength was improved at least 26%, and the elongation ratio directly related to the high temperature fatigue property was improved about 60% or more.

This improvement of the material properties can reduce the cost and time required to develop a novel engine type or design because it can apply the rigidity and high temperature property required for a high output engine without any special material development to the proven material for mass production.

Further, in a production step, it is expected to obtain effects of enhancing yield, minimizing cycle time and reducing weight by improving the material rigidity by applying high pressure die casting having excellent productivity, and can reduce the generation amount of the core gas 100%.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

What is claimed is:

1. A cylinder head comprising:
a lower part having a combustion chamber face, and a water jacket face, wherein the water jacket face is on the opposite side as the combustion chamber face, and the lower part is prepared by casting or forging; and
an upper part having a water jacket face and a cam installation face, wherein the upper part is prepared by casting or forging, the water jacket face is opposite the cam installation face, and the water jacket face of the upper part is connected to the water jacket face of the lower part, thereby forming the cylinder head with the water jacket in between the lower part and the upper part.

2. The cylinder head of claim 1, wherein the lower part is prepared by a gravity casting method.

3. The cylinder head of claim 1, wherein the lower part comprises an aluminum (Al) alloy.

4. The cylinder head of claim 3, wherein the Al alloy comprises Al, Cu in the range of 2.0 to 4.0 wt %, Si in the range of 5.0 to 7.0 wt %, Mg in the range of 0.1 to 0.4 wt %, Zn in the range of 1.0 wt % or less, Fe in the range of 0.25 wt % or less, Mn in the range of 0.03 wt % or less, Ni in the range of 0.3 wt % or less, and Ti in the range of 0.03 wt % or less.

5. The cylinder head of claim 4, wherein the amount of Zn, Fe, Mn, Ni, and Ti is more than 0 wt %.

6. The cylinder head of claim 4, wherein the top and bottom faces are heat treated after casting with a solution treatment of 500° C./3 hours, and an aging treatment of 250° C./2.5 hours.

7. The cylinder head of claim 1, wherein the upper part of the cylinder head is prepared by a die casting method.

8. The cylinder head of claim 1, wherein the upper part comprises an aluminum (Al) alloy.

9. The cylinder head of claim 8, wherein the Al alloy comprises Al, Cu in the range of 1.5 to 3.5 wt %, Si in the range of 9.6 to 12.0 wt %, Mg in the range of 0.3 wt % or less, Zn in the range of 1.0 wt % or less, Fe in the range of 1.3 wt % or less, and Mn in the range of 0.5 wt % or less.

10. The cylinder head of claim 9, wherein the amount of Mn, Zn, Fe, and Mn is more than 0 wt %.

11. The cylinder head of claim 9, wherein the top and bottom faces are subjected to a heat treatment of 250° C./2.5 hours after casting.

12. The cylinder head of claim 1, wherein the upper part and lower parts are connected by an inorganic binder.

13. The cylinder head of claim 6, wherein the upper part and lower parts are connected to each other by an inorganic binder and a metal gasket located between the water jacket face of the upper part and the water jacket face of the lower part.

14. The cylinder head of claim 1, wherein the upper part and lower part of the cylinder head are pre-assembled with a head bolt.

15. A method of manufacturing the cylinder head of claim 1 comprising:
casting the lower part by a gravity casting method;
heat treating the water jacket face and the combustion chamber face of the lower part after casting;
casting the by a die casting method;
heat treating the cam installation face and the water jacket face of the upper part after casting; and
connecting the upper and lower parts to each other by coating an adhesive on the water jacket face of the lower part and the water jacket face of the upper part, thereby producing the cylinder head,

16. The method of claim 15, further comprising:
inserting a gasket between the upper part and the lower part.

17. The method of claim 15, further comprising:
pre-assembling the cylinder head by installing a head bolt that penetrates the upper and lower parts of the cylinder head, thereby assembling the cylinder head.

18. The method of claim 15, wherein the heat treating step for the lower part comprises subjecting the combustion chamber face and the water jacket face to a solution treatment of 500° C./3 hours and an aging treatment of 250° C./2.5 hours.

19. The method of claim 15, wherein the heat treating step for the upper part casting step further comprises subjecting the cam installation face and the water jacket face to a heat treatment of 250° C./2.5 hours.
